(19) United States
(12) Patent Application Publication
(10) Pub. No.: US 2006/0005792 A1
(43) Pub. Date: Jan. 12, 2006

(54) Lightweight valve

(75) Inventors: Arndt Bosler, Stuttgart (DE); Rainer Joos, Kernen (DE); Detlef Nowotni, Grabenstetten (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Daimler Chrysler, Stuttgart (DE)

(21) Appl. No.: 10/506,593

(22) PCT Filed: Mar. 4, 2003
(86) PCT No.: PCT/EP03/02178

§ 371 Date: Aug. 15, 2005

(30) Foreign Application Priority Data
Mar. 5, 2002 (DE) 102 09 770.4

(51) Int. Cl. F01P 1/08; F02N 3/00

(52) U.S. Cl. 123/41.41; 123/188.3

(57) ABSTRACT

The invention relates to a lightweight valve that consists of a valve base, the latter comprising a valve stem and a hollow valve cone, and a valve head cover, whereby the valve base is linked with the valve head cover by means of a material-displacing welding method. A weight-reducing cavity is defined between the valve cone and the valve head cover in the assembled state of the valve, said cavity being provided with a stability-enhancing support structure. Suitable welding methods are projection welding, capacitor discharge welding and friction welding.

The present invention is directed to a lightweight valve as recited in the definition of the species in claim 1, as known for example from DE 198 04 053 A1. In addition, the present invention relates to a method for producing such a lightweight valve as recited in the definition of the species in claim 5.

The use of weight-optimized valves in combustion engines renders it possible to significantly reduce the power losses to friction in valve operation. This is especially significant for combustion engines with high rotational speeds, but also plays an important role for alternative valve operating systems that are not based on a conventional camshaft control. Besides the use of light materials (such as silicon nitride ceramic, titanium or aluminum alloys or titanium aluminides), the valve weight may be reduced in particular by incorporating cavities into the valve stem and/or the valve cone.

Known from the species-forming German Patent Document DE 198 04 053 A1 is a hollow lightweight valve having a stem, a valve cone, and a valve disk, the valve cone and valve disk together forming a cavity. The valve cone and valve disk are thin-walled individual parts which are joined to each other and to the valve stem by soldering or welding. To achieve high strength and rigidity of the valve—in particular in the area of the valve cone—despite the minimal wall thickness, the cavity of the valve is provided with a support structure which braces the valve disk cover against the stem. This support structure is intended to minimize the deformation of the valve head under load and to inhibit the formation of cracks in the area of the valve head.

In the embodiments of the lightweight valve shown in DE 198 04 053 A1, the valve cone and valve disk are joined via fillet welds; possible welding methods for this are in particular the common fusion welding methods such as TIG, laser or electron beam welding. However, these welding methods are only conditionally usable due to the comparatively high heat development when used in the case of thin-walled valve geometries, in particular when the cavity of the valve is filled with a metal cooling medium: Because of the spatially tightly proximate arrangement of cooling metal and welding surface, there is a danger in these cases that the cooling metal will hot-melt and reach the weld area, which may result in a significant reduction in the strength and tightness of the weld. In order to avoid this problem, the cooling medium may be added later—i.e., after the welding is finished; however, this is accompanied by an additional procedural step of closing the cavity, and is therefore very expensive. A further disadvantage of the forenamed welding methods is that the process times (allowing for positioning and aligning the valve disk with respect to the valve cone, possibly subsequently adding the cooling metal and then closing the cavity) are uneconomically long. For some material combinations of the valve disk and valve cone, for example for parts made of titanium-based alloys, a protective gas atmosphere or vacuum is also necessary when using this welding method, which further increases the production expense and hence the costs of such a lightweight valve.

The present invention is therefore based on the object of providing a lightweight valve which has high stability in the face of the thermal and mechanical operating loads and is also simple and economical to produce. In addition, the present invention is based on the object of making a production method for such a lightweight valve available which is suitable for large series production.

The object is achieved according to the present invention by the features of claims 1 and 5.

Accordingly, the lightweight valve is made up of a valve body—which for its part includes the valve stem and the hollow valve cone—and a valve disk cover, which is joined to the valve cone via a compression connection welding method. Formed between valve cone and valve disk cover when the valve is in the assembled position is a weight-reducing cavity which is provided with a strength-increasing support structure.

The compression connection welding methods have the advantage—in contrast to the common fusion welding methods—that these methods involve locally closely limited warming of the welding zone. Therefore, when these methods are used negligible warping of the workpieces occurs. Furthermore, process-secure welding of the thin-walled valve components is therefore possible without the danger of weakening the welding zone (for example through contamination of the welding surface by molten cooling metal). Moreover, with the use of these methods, it is possible to join a broad spectrum of different material combinations without protective gas. Furthermore, with the compression connection welding methods—in contrast to fusion welding—there is no “welding path” in the actual meaning of the word, along which a welding head would have to be guided; therefore when using a material-displacing welding method it is possible to utilize the rotational symmetry of the valve being produced to achieve a very simple—and hence economical—highly precise relative positioning of the individual parts in the employed welding device.

Possible welding methods for joining the valve body with the valve cover are in particular friction welding or a resistance compression welding method.

In friction welding, the heat needed to weld the valve disk cover to the valve body is produced by relative movement of the individual components, which are pressed against each other (see claim 6). To this end, the valve body for example is set in rotation, while the valve disk cover is firmly clamped into an axially movable device and pressed against the rotating valve body. When the temperature and plasticity needed for welding are reached, the rotating valve body is braked and at the same time the contact pressure is increased, so compressing the valve body against the valve disk cover produces a welding of the two parts in a ring-shaped contact zone. The welding parameters (rotational speed, friction force, moment of braking, and compression, etc.) depend on the combination of materials and the geometry of the joining parts in the welding zone.

In resistance compression welding (for example projection welding or capacitor discharge welding), the workpieces to be welded—valve body and valve disk cover—are clamped into the welding device in such a way that the two workpieces are touching each other along a ring-shaped contact zone. The valve body and valve disk are welded to each other in this contact zone by the high current flow (caused for example by the discharge of a capacitor), so that a continuous ring-shaped connection is formed between the two workpieces (see claim 7). Since the welding pulse is very short (about 10 to 15 milliseconds in capacitor discharge welding), and since the currents are introduced into a locally closely limited area, only slight warping of the workpiece occurs.

In both projection welding and capacitor discharge welding, the quality of the resulting weld depends substantially on a continuous ring-shaped contact area being formed between the valve body and valve disk cover, along which the local material heating and welding occur. In an especially easily producible embodiment, the valve disk cover blank has a circumferential edge in the edge area on the side facing the valve body, which meets the valve body on a conically shaped area of the valve body in the assembled position (see claim 8). In another easily produced embodiment of the present invention, the valve disk cover blank is provided with an edge area, part of which is the shape of a truncated cone, while the valve body blank has an edge between a hollow cylindrical section and a planar section in the area of contact with the valve disk cover blank (see claim 9). In both cases, a ring-shaped edge meets a conically shaped opposite area, resulting in a high-strength ring-shaped weld.

Advantageously, a one-piece valve body blank (having a valve stem and a valve cone) is used to make the lightweight valve (see claim 2). This has the advantage that the production of the valve body blank does not require an additional procedural step to join the valve stem to the valve cone; furthermore, the risk of a loss of strength due to faulty joining of the individual parts is eliminated in the case of one-piece valve bodies.

In an advantageous embodiment of the present invention, the cavity between the valve cone and valve disk cover is filled with a cooling medium, which improves the dissipation of heat from the thermally heavily loaded areas of the valve disk cover and the adjoining zones of the valve cone (see claim 3). Sodium is used in particular as the cooling medium. The good heat conductivity of sodium is utilized here, but in particular the transfer of the heat by the vibrating motion of the valve in operation, whereby hot sodium is transported to cooler areas, gives off heat there, and when cooled is available again to absorb heat in the hotter disk area. Instead of sodium, other metals with a low melting point such as potassium or potassium-sodium alloys may also be used.

It is particularly advantageous to extend the cavity in the interior of the valve into the valve stem (see claim 4). This offers great advantages, in particular when the cavity is filled with a cooling medium, since in this case the cooling medium may be transported by the vibrating motion of the valve from the hot area of the valve disk into the cooler interior of the stem, where it undergoes particularly effective cooling due to the greater temperature differential.

The present invention will be explained in greater detail below on the basis of a plurality of exemplary embodiments depicted in the drawing.

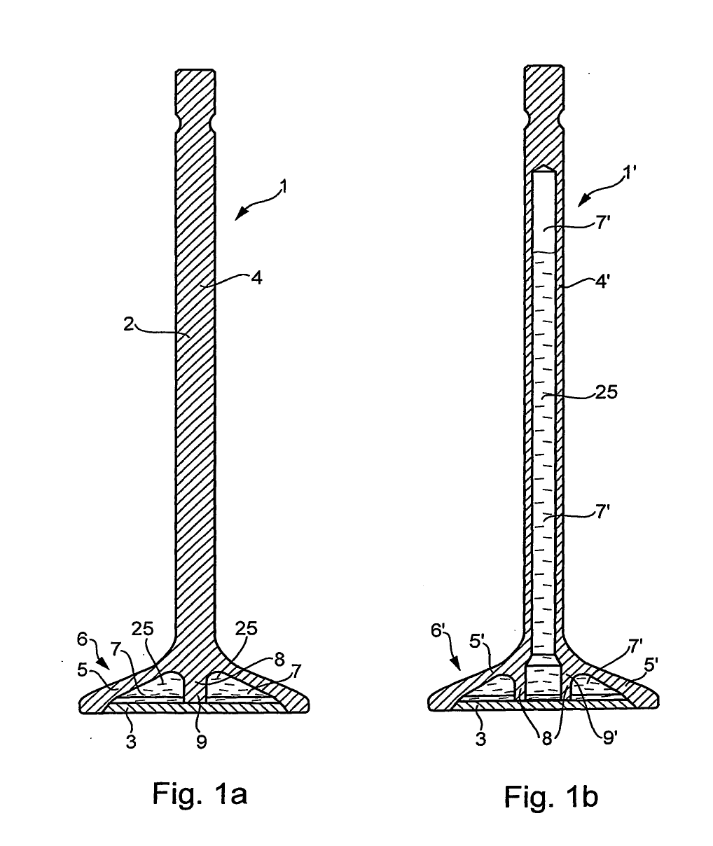

FIG. 1a shows a lightweight valve according to the present invention;

FIG. 1b shows an alternative design of the lightweight valve according to the present invention;

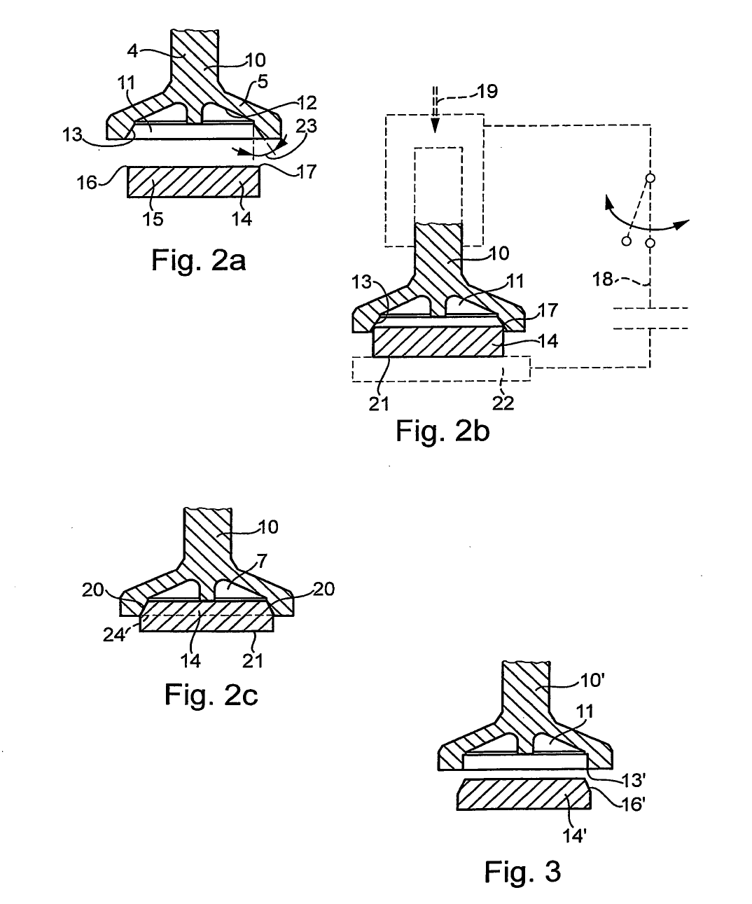

FIG. 2 shows a schematic representation of the procedural steps in making the lightweight valve of FIG. 1a: valve body blank and valve disk cover blank . . .

FIG. 2a . . . before welding;

FIG. 2b . . . during welding

FIG. 2c . . . in the finished welded state.

FIG. 3 shows an alternative design of the blanks to be welded.

FIG. 1a shows a schematic representation of a lightweight valve 1 according to the present invention including a valve body 2 and a valve disk cover 3, which are welded together by a compression connection welding method. Valve body 2 is made up of a valve shaft 4 and a hollow valve cone 5, and has a one-piece design in the present exemplary embodiment. Valve cone 5 and valve disk cover 3 together form valve head 6. A weight-optimizing cavity 7 is formed between valve cone 5 and valve disk cover 3. A support structure 8 positioned in cavity 7 supports valve disk cover 3 vis-a-vis stem 4; in the present case support structure 8 is formed by a pin 9 centered in cavity 7. Instead of one-piece valve body 2 shown in FIG. 1, a valve body assembled of a plurality of individual parts (for example using different materials for the stem and the valve cone) may be utilized.

Valve disk cover 3 may be welded to valve cone 5 according to the present invention, using capacitor discharge welding. The associated procedural steps are represented schematically in FIGS. 2a through 2c. A valve body blank 10 is assumed that is provided with an internal cavity 11 in the area of valve cone 5—as depicted in FIG. 2a. In interior space 11 of valve cone 5 is a support structure 8, which projects a predefined depth into interior space 11. A conically shaped joining zone 13 is provided on wall 12 of interior cavity 11. Valve body blank 10 may be produced by shaping (forging, extrusion, etc.) and/or by machining. The other part in the joint is a valve disk cover blank 14, which has the form of a cylindrical disk 15 in the present example; joining zone 16 provided on valve disk cover blank 14 thus has the form of a ring-shaped edge 17 with a right-angled contour.

For welding the two joining parts 10, 14, valve disk cover blank 14 is inserted into cavity 11 of valve body blank 10; circumferential edge 17 of valve disk cover blank 14 then makes linear contact with conical joining zone 13 in interior cavity 11 of valve cone 5. Then, using a compressor discharge welding device 18 (indicated schematically by broken lines in FIG. 2b), valve disk cover blank 14 is pressed into interior space 11 of valve body blank 10 (arrow 19 in FIG. 2b), and at the same time the capacitor integrated into the power circuit of welding device 18 is discharged; because of the high currents flowing through joining parts 10, 14, edge 17 is welded to joining area 13 opposite it on valve body blank 10, so that a continuous ring-shaped connection 20 is formed between valve disk cover blank 14 and valve body blank 10, and cavity 7 formed between the two joining parts 10, 14 is closed off tightly from the outside world. Since the welding pulse in capacitor discharge welding is very short, 10-15 milliseconds, only slight warping of joining parts 10, 14 occurs. The flat underside of valve disk cover blank 14 ensures a large contact area 21 with welding die 22 of capacitor discharge welding device 18. This contact area 21 is parallel to ring-shaped edge 17, which permits precisely directed and uniform pressing of entire edge 17 against opposing joining surface 13 of valve body blank 10. The fact that contact area 21 is significantly larger than the (approximately linear) area of contact of edge 17 on joining area 13 of valve body blank 10 ensures that the material heating and plasticizing during welding takes place reliably at edge 17.

Conical angle 23 of conical joining area 13 is preferably between 10° and 80°. The diameter of disk 15 is matched to the diameter and conical angle 23 of joining area 13 and the welding parameters (current strength, contact pressure, etc.) are chosen so that valve disk cover blank 14 penetrates so deeply into interior cavity 11 during welding that it rests against support structure 8; this ensures that valve disk cover 3 is braced against valve stem 4 by support structure 8 during later operation.

The use of capacitor discharge welding allows a broad spectrum of different materials to be welded, so that the materials of valve body 10, 2 and valve disk cover 14, 3 may be selected according to the other (e.g., functional) requirements. In particular, all known valve materials, as well as for example titanium aluminides, iron aluminides, metal matrix composite materials, titanium and aluminum alloys etc., may be utilized and combined with each other. The method is thus also usable in particular for applications for which other welding methods are unusable, or usable only with difficulty.

An alternative design of joining areas 13′, 16′ on valve body blank 10′ and valve disk cover blank 14′ is shown in FIG. 3: In this case, joining area 16′ on valve disk cover blank 14′ has the form of a truncated cone, while a circumferential edge 13′ is provided on valve body blank 10′. Analogous to the example of FIGS. 2a and 2b, the contact area between the two blanks 10′, 14′ is provided here too by a ring-shaped circumferential linear contour. In addition to the exemplary embodiments of joining parts 10, 14 shown in FIGS. 2a and 3, any other desired geometries are possible; it is essential that two joining parts touch each other in a ring-shaped circumferential linear contact zone when in position for assembly.

As an alternative to capacitor discharge welding, the two parts to be joined may also be joined by projection welding, circumferential edge 17, 13′ acting on valve body blank 10, 10′ or valve disk cover blank 14, 14′ as an ignition-initiating projection.

In addition, the two parts to be joined may be joined to each other by friction welding. In this case, valve disk cover blank 14 for example is held in the friction welding machine so that it is not able to rotate but may move axially, while valve body blank 10 is mounted and driven so that it rotates in a fixed position. First, valve disk cover blank 14 is pressed against conical joining area 13 of valve cone 5, initially still with moderate axial force, the material of both parts located near the contact zone heating up and becoming soft as a result of the friction. If a temperature appropriate for welding is reached and a doughy condition is reached in the contact zone of the parts, rotating valve body blank 10 is very quickly stopped and at the same time the axial force of valve disk cover blank 14 is increased and the latter is pressed into internal cavity 11 of valve cone 5, by a certain axial stroke. As that happens, parts 10, 14 become deeply welded to each other at the contact zone. In contrast to projection and capacitor discharge welding, friction welding does not require the contact area between the two joining parts 10, 14 to be linear; instead it may be useful—depending on the wall thickness and the geometry of joining parts 10, 14 in the joining area—to provide a two-dimensional contact zone.

After joining parts 10, 14 have been welded, valve 1 is machined; an area of valve disk cover blank 14 that projects from valve cone 5 is machined down to the desired dimension (broken line 24 in FIG. 2c) and any remaining welding burr etc. is removed.

An alternative embodiment of a lightweight valve 1′ according to the present invention is depicted in FIG. 1b. In this case, cavity 7′ extends into valve stem 4′. In this exemplary embodiment, support structure 8 is formed by a plurality of pins 9′, which are positioned equidistant on a circular arc. Cavity 7′ is filled with a cooling medium 25 (for example sodium), which is present in liquid aggregate state at the normal operating temperatures of valve 1′. During operation of valve 1′, cooling medium 25 therefore flows through cavity 7′ and thus supports the dissipation of heat from the hot area of valve head 6′ into cooler stem area 4′. To produce valve 1′ of FIG. 1b, interior space 11 of valve body blank 10, 10′ is first filled with cooling medium 25, and then—using one of the methods described above—is welded to valve disk cover blank 14, 14′. For the welding, the cooling medium is either pressed in its solid aggregate state into interior space 11 of valve body 10, 10′ and held in place there by support structure 8, and/or valve body blank 10, 10′, containing (liquid or solid) cooling medium 25 in its interior space 11, is oriented vertically during welding in such a way that cooling medium 25 cannot escape.

Alternatively to or in addition to pins 9′ shown in FIGS. 1a and 1b, inner support structure 8 may also have ring-shaped circumferential support walls and/or laterally projecting support ribs. The wall thickness of valve cone 5 or of valve disk cover 3 may be purposefully optimized—taking into account the design of support structure 8—in order to further reduce the weight of valve 1, 1′.

1-9. (canceled)

10. A lightweight valve comprising:
a valve body including a valve stem and a valve cone;
a valve disk cover compression welded to the valve cone, a cavity being disposed between the valve cone and the valve disk cover; and
a support structure disposed in the cavity and bracing the valve disk cover against the valve stem.

11. The lightweight valve as recited in claim 10, wherein the lightweight valve is a combustion engine valve.

12. The lightweight valve as recited in claim 10, wherein the valve body is integrally formed as a single part.

13. The lightweight valve as recited in claim 10, further comprising a cooling medium disposed in the cavity.

14. The lightweight valve as recited in claim 13, wherein the cooling medium includes sodium.

15. The lightweight valve as recited in claim 10, wherein the cavity extends into the valve stem.

16. A method for making a lightweight valve, the method comprising:
providing a valve body blank including a valve stem and a partially hollow valve cone;
providing a valve disk cover blank; and
welding the valve body blank to the valve disk cover blank using compression connection welding.

17. The method as recited in claim 16, wherein the compression connection welding includes friction welding.

18. The method as recited in claim 16, wherein the compression connection welding includes resistance compression welding.

19. The method as recited in claim 18, wherein the resistance compression welding includes at least one of projection welding and capacitor discharge welding.

20. The method as recited in claim 16, wherein the partially hollow valve cone includes an interior space and a partially conically shaped wall and the valve disk cover blank has a joining area having an edge, and wherein the welding includes welding the edge to the partially conically shaped wall.

21. The method as recited in claim 16, wherein the valve disk cover blank includes a partially truncated cone-shaped boundary area and the valve body blank includes an interior space delimited by a linear edge, and wherein the welding includes welding the boundary area to the linear edge.

22. The method as recited in claim 16, wherein the lightweight valve is a combustion engine valve.
